(19) United States
(12) Patent Application Publication
(10) Pub. No.: US 2024/0157583 A1
(43) Pub. Date: May 16, 2024

(54) Suction device and apparatus

(71) Applicant: RightHand Robotics, Inc., Somerville, MA (US)

(72) Inventors: Timothy Fofonoff, Cambridge, MA (US); Nicholas Payton, Somerville, MA (US); Vivian Lee, Somerville, MA (US)

(21) Appl. No.: 18/376,302

(22) Filed: Oct. 3, 2023

Related U.S. Application Data
(60) Provisional application No. 63/413,248, filed on Oct. 4, 2022.

(51) Int. Cl. B25J 15/06; B65G 47/91

(52) U.S. Cl. CPC B25J 15/0683; B65G 47/91

(57) ABSTRACT

Suction cup devices and apparatus for performing a picking operation. The suction cup apparatus includes a first suction device including a housing portion, wherein the housing portion is shaped to define an opening through which a suction force can be applied to enable the first suction device to grasp an item, and a rounded interior pocket adjacent to the opening of the housing portion, wherein the rounded interior pocket is shaped to contact at least a portion of the item during the picking operation.

### CROSS-REFERENCE TO RELATED APPLICATIONS

The present application claims the benefit of and priority to co-pending United States provisional application No. 63/413,248, filed on Oct. 4, 2022, the entire disclosure of which is incorporated by reference as if set forth in its entirety herein.

### TECHNICAL FIELD

Embodiments described herein generally relate to robotic devices and methods and, more particularly but not exclusively, to robotic devices and methods for grasping items.

### BACKGROUND

Logistic operations such as those in warehouse environments often include robotic devices to gather items from a first location (e.g., a container) and place the items at a second location (e.g., on a conveyor belt). Accordingly, these operations require the robotic device to first grasp the item. Existing robotic devices often include a suction device that generates a suction force to “grasp” the item.

Existing picking devices are typically designed for a narrow range of items and those with similar features. For example, a picking device may have a suction device shaped to grasp boxes of a particular size. Similarly, a picking device may be configured to only grasp items that have a particular shape, weight, material, surface, etc. This limits a picking device's utility, as it can only grasp items with certain characteristics.

Similarly, small items limit the number and size of suction cup devices that may be used. Larger items, on the other hand, may swing and detach from the suction device(s). This is particularly true if the robotic device moves rapidly during the picking operation. Accordingly, large items may require multiple large, widely-spaced suction cups.

If an item is flexible, as is the case with bags that may contain one or more or items, the bag may collapse and wrinkle when loaded at a suction site. Although flexible picking devices may be used, the suction device should be at least as flexible as the bag to create a good seal with the bag. This, however, may result in prohibitively fragile suction cup designs.

A need exists, therefore, for suction cup devices that overcome the disadvantages of existing devices.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a suction apparatus for performing a picking operation. The suction apparatus includes a first suction device having a housing portion, wherein the housing portion is shaped to define an opening through which a suction force can be applied to enable the first suction device to grasp an item; and a rounded interior pocket adjacent to the opening of the housing portion, wherein the rounded interior pocket is shaped to contact at least a portion of the item during the picking operation.

In some embodiments, the suction apparatus further includes a convexed lip portion at the opening such that the item slides against the convexed lip portion during the picking operation.

In some embodiments, the opening has a first diameter and the housing portion has a second diameter that is greater than the first diameter.

In some embodiments, the suction apparatus further includes a mesh portion within the rounded interior pocket, wherein the mesh portion includes a plurality of apertures to distribute a low pressure force in the rounded interior pocket. In some embodiments, the mesh portion traverses a circumference of the rounded interior pocket. In some embodiments, the mesh portion has a curved shape to allow for a flexible item to conform to the mesh portion during the picking operation. In some embodiments, the mesh portion is shaped to allow a vacuum around the rounded interior pocket. In some embodiments, the housing portion is configured to allow a free flow of air around the mesh portion regardless of whether the item seals off a portion of a surface of the rounded interior pocket.

In some embodiments, the suction apparatus further includes an external lip portion extending from the opening and configured to be in operable contact with the item during the picking operation.

In some embodiments, the suction apparatus further includes an internal lip portion extending from the opening and into the rounded interior pocket, wherein the internal lip portion is configured to conform to the item during the picking operation.

In some embodiments, the suction apparatus further includes a linear extension member extendable through a center of the housing portion, and a second suction device operably connected to the linear extension member and including an opening through which a suction force can be applied to enable the second suction device to obtain an initial grasp on the item.

According to another aspect, embodiments relate to a method for performing a picking operation. The method includes positioning a linear extension member within a first suction device, wherein the first suction device includes a housing portion, wherein the housing portion is shaped to define an opening through which a suction force can be applied to enable the first suction device to grasp an item, and a rounded interior pocket adjacent to the opening of the housing portion, wherein the rounded interior pocket is shaped to contact at least a portion of the item during the picking operation; moving, using the linear extension member, a second suction device toward an item to be grasped to enable the second suction device to obtain an initial grasp on the item; and retracting the linear extension member to the first suction device to enable the first suction device to grasp the item.

In some embodiments, the first suction device includes a convexed lip portion at the opening such that the item slides against the convexed lip portion during the picking operation.

In some embodiments, the opening of the first suction device has a first diameter and the housing portion has a second diameter that is greater than the first diameter.

In some embodiments, the first suction device further includes a mesh portion within the rounded interior pocket, wherein the mesh portion includes a plurality of apertures to distribute a low pressure force in the round interior pocket. In some embodiments, the mesh portion traverses a circumference of the rounded interior pocket. In some embodiments, the mesh portion has a curved shape to allow for a flexible item to conform to the mesh portion during the picking operation.

In some embodiments, the first suction device further includes an external lip portion extending from the opening and configured to be in operable contact with the item during the picking operation.

In some embodiments, the first suction device further includes an internal lip portion extending from the opening and into the rounded interior pocket, wherein the internal lip portion is configured to conform to the item during the picking operation.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a gripping device in a warehouse environment in accordance with another embodiment;

FIG. 2 illustrates a cross-sectional view of a suction cup device in accordance with one embodiment;

FIGS. 3A & 3B illustrate a cross-sectional view of the suction cup device of FIG. 2 performing a picking operation in accordance with one embodiment;

FIG. 4 illustrates a cross-sectional view of a suction cup device in accordance with another embodiment;

FIGS. 5A & 5B illustrate a cross-sectional view of a nested suction cup apparatus performing a picking operation in accordance with one embodiment; and

FIGS. 6A & 6B illustrate a cross-sectional view of a suction cup apparatus in accordance with another embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed previously, existing devices for performing grasping operations on flexible items suffer from various drawbacks. These drawbacks may relate to being unable to achieve a proper grip on the flexible item or damaging the item.

Additionally, obtaining a single or known number of items can be a requirement of a picking operation. However, obtaining a single or known number of items can be difficult if items are soft or otherwise non-rigid, when multiple suction devices are used together in an array, or with larger suction devices.

The embodiments herein provide novel suction cup devices and systems for performing picking operations. The suction cup devices described herein include a housing portion and a rounded interior pocket configured and shaped to receive a flexible item during a picking operation. In some embodiments, the housing portion may be made from or otherwise include a rigid material.

In some embodiments, the suction cup devices may be implemented in a “nested” configuration in which a first suction device is nested within a second suction device. In these embodiments, the first suction device may be configured to extend toward an item to obtain an initial grasp on the item, and then retract toward the second suction device. The second suction device may then also grasp the item.

By obtaining an initial grasp, the embodiments described herein obviate the above-discussed difficulties in obtaining a single or known number of items. The second suction device may then grasp the item to provide a stronger grasp, for example, for transportation.

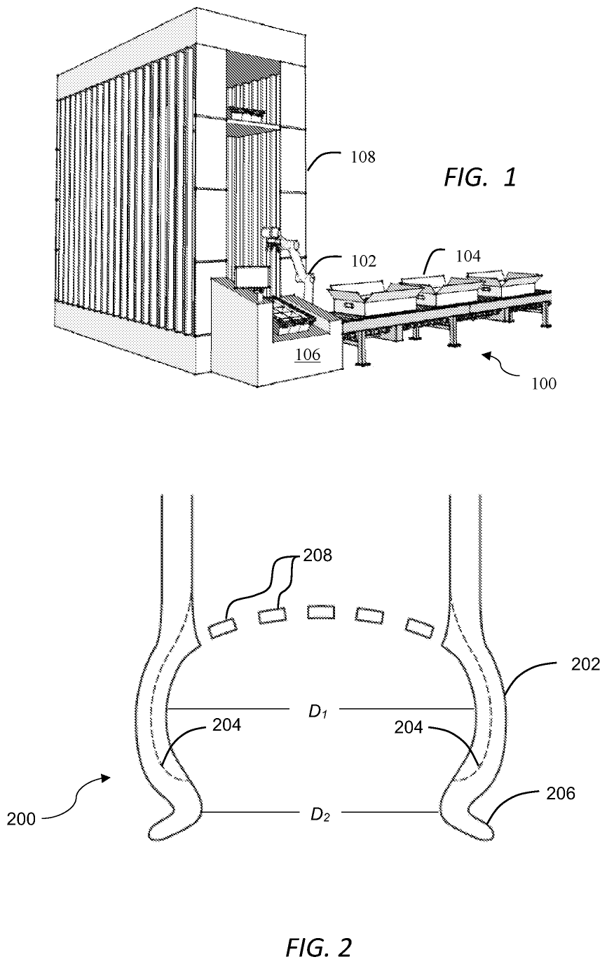

The embodiments described herein may be implemented in a variety of applications. For example, FIG. 1 illustrates an exemplary application in a warehouse environment 100 in which a gripping device 102 may be tasked with picking items from one or more containers 104, and placing the items at a loading station 106. These items may then be placed in a shipping container 108 for further shipment, sorting, processing, or the like.

Suction cup devices grasp items by creating a seal between the suction cup and an item. A vacuum or other type of suction force generator draws air out of a volume between the suction cup and the item such that the surface of the item that is “within” the suction cup is exposed to low pressure. This allows external air pressure to push the item toward the suction cup and allow the suction cup to maintain a grasp on the item. The quality of the grasp is contingent on creating a quality seal between the cup and the item and also maximizing the surface area of the item that is “within” the suction cup or otherwise exposed to low pressure.

Existing suction cup designs can generally grasp rigid items. However, they may struggle if the item is flexible, such as with polybags containing several items. These types of items are likely to collapse and wrinkle when loaded at a suction site.

When grasped by suction device, a polybag will deflect downward such that the polybag film is in tension. At the point(s) of contact between the film and the suction cup, the film will be in pure shear relative to the cup. This shrinks or otherwise reduces the total cross-sectional area of the low pressure that is pulling the item toward the cup. As a result, cups rely mostly on friction between a portion of the cup and the bag, with the pressure pressing them together.

During a grasp, the deflected position of the cup edge is almost always significantly deflected from the natural resting position of the edge. Any small failure of the seal would allow the cup edge to separate from the item. This cup edge would then naturally move away from the item and cause the entire grip to fail. To remedy this, some existing cups are configured to invert once attached to an item so that the lip is pressed toward the item during engagement. However, these suction cups must be flexible, and the decrease in the suction area due to shear remains.

With most suction cup devices, it is critical that airflow within the cup be relatively free to the seal's edge to ensure the pressure difference keeps the seal pressed against the item. If a secondary seal forms further into the cup (i.e., away from the edge), the difference between the external and internal pressures will be reduced near the intended seal. Not only does this weaken the intended seal, but it also decreases the area of the item that is exposed to lower pressure.

The embodiments described herein provided improved suction cup devices and methods of operating the same. A suction apparatus in accordance with the described embodiments may include a suction device with a housing portion with an opening through which a suction force can be applied to grasp an item. The housing portion also includes a rounded interior pocket adjacent to this opening. This rounded interior pocket is shaped to contact at least a portion of a bagged item during the picking operation. The housing portion may be configured as or from a rigid material.

The disclosed suction apparatus may be particularly suited for grasping items such as polybags or other types of flexible items. In accordance with the embodiments herein, during a picking operation a portion of an item, such as a polybag, may be pulled up into the rounded interior pocket.

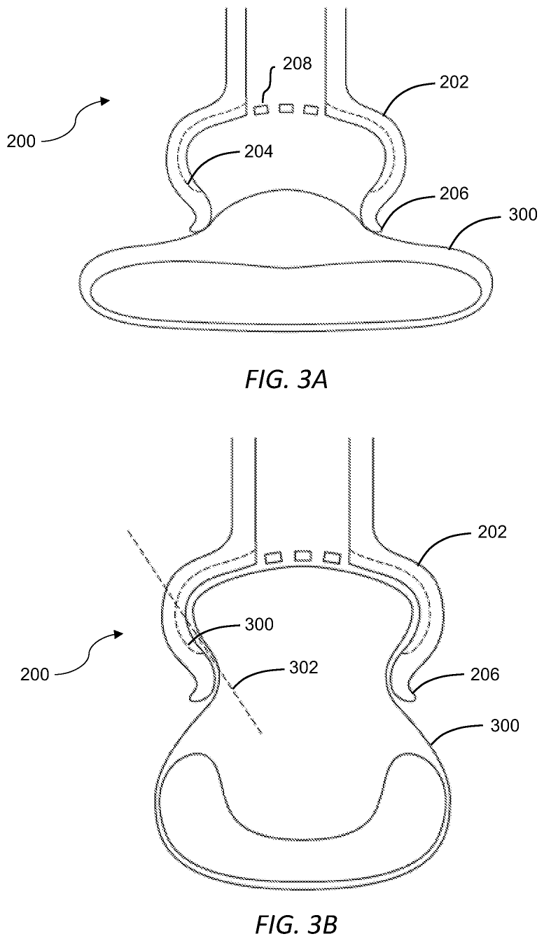

FIG. 2 illustrates a cross-section view of a suction cup device 200 in accordance with one embodiment. The suction cup device 200 may be specifically designed to pick deformable or flexible items such as polybags.

The suction cup device 200 includes a housing portion 202 and a rounded interior pocket 204. The rounded interior pocket 204 may circumvent the interior of the housing portion 202.

As discussed previously, the housing portion 202 may be formed from a rigid material such as metal, rubber, or plastic including flexible polymers such as polyurethanes. In some embodiments, one or more materials, including those with different material properties such as durometer and friction coefficient, could be used in combination by manufacturing them together such as through overmolding. In some embodiments, materials with different properties may be used in combination by assembling them together (e.g., by a stretching a lip portion over a mechanical feature such as a barb). In some embodiments, the housing portion may be formed from a compliant material.

In some embodiments, the housing portion may be formed as a bellows portion. In these embodiments, the bellows may at least partially collapse upon or after obtaining a grasp an item.

The suction cup device 200 may also include a lip portion 206 extending about the circumference of the housing portion 202. The lip portion 206 may be formed from a rigid material. In operation, as the suction cup device 200 applies a suction force to grasp an item, the item may first slide against the lip portion 206.

In some embodiments, the friction of the lip portion 206, the item, or the housing portion 202 in general may be selectively modified based on choice of material. Additionally or alternatively, some embodiments may include teeth-like features within the housing portion 202 or at the slots 208 to enhance the overall grip of the item.

The suction cup device 200 may also include one or more slots 208 or holes (for simplicity, “slots”) to act as vents. These slots 208 may help support and prevent damage to the item during a picking operation. In some embodiments, the slots 208 may be formed as or include mesh portion configured on the housing portion 202. In some embodiments, the housing portion 202 may include a porous foam, such as near the slots 208, to protect soft items such as polybags from damage.

The housing portion 202 may have a larger interior diameter D₁. The lip portion 206 may have an internal diameter D₂ at its opening. The internal diameter D₁ is larger than the internal diameter D₂ of the lip portion 206.

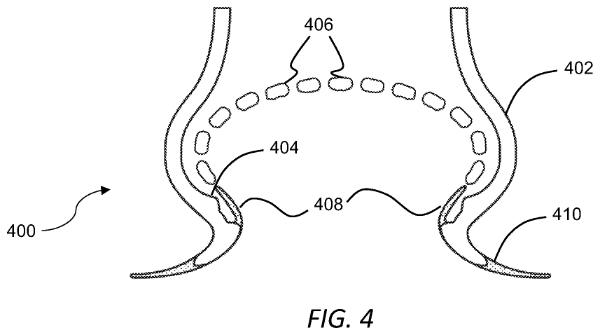

FIGS. 3A & 3B illustrate a cross-section view of the suction cup device 200 of FIG. 2 performing a picking operation in accordance with one embodiment. The suction cup device 200 may be tasked with performing a picking operation on a flexible item such as a polybag.

In operation, a robotic manipulator such as a robotic arm (not shown in FIGS. 3A & 3B) may move the suction cup device 200 toward the item 300. The suction cup device 200 may be in operable connection with a vacuum or otherwise a suction force generator to provide a suction force through the lip portion 206.

As the suction cup device 200 moves toward the item, the suction force may pull the item toward the suction cup device 200. Specifically, the suction force may begin pulling the item 300 up into the rounded interior pocket 204. This at first forms a bubble with a weak seal between the item 300 and the lip portion 206.

There may also be folds, wrinkles, or creases in the item 300 at this seal or possibly other locations where the item 300 contacts the lip portion 206. This is due to the flexible nature of the item 300.

As the bubble grows, the item 300 will continue to slide along the lip portion 206 and into the interior pocket 204. As the item 300 continues to slide into the suction cup device 100, it will eventually contact the components such as a mesh portion forming the slots 208, or any other components or parts of the housing portion 202.

Once the suction force pulls the item 300 into the housing portion 202, a bubble as seen in FIG. 3B will be fully formed. In this situation, the item 300 will press against the interior pocket 204 with low pressure distributed across the entire surface of the bubble.

The actual seal will occur at or near the lip portion 206. As the suction force is applied, this seal will be maintained because tension in the item 300 (e.g., the film of the item 300) pulls the item 300 against the lip portion 206. The seal is therefore self-reinforcing. However, the seal may break if the item 300 is pulled away from the suction cup device 200 at an angle that is greater than the angle at which the lip portion 206 meets the interior pocket 204 (illustrated as dashed line 302).

In order for the item 300 to be pulled from the suction cup device 200 or otherwise out of the interior pocket 204, the item 300 must slide around the lip portion 206 and pull the surface of the item 300 away from the interior pocket 204. Additionally, Capstan friction between the item 300 and the lip portion 206 adds to the force needed to pull the item 300 out of the suction cup device 200.

As discussed previously, the suction cup device 200 may include one or more mesh portions within the housing portion. The mesh portion may be positioned adjacent to one or more holes or slots 208 as discussed previously. For example, if the housing portion 202 includes holes or slots toward the top of the suction cup device (i.e., the end opposite the lip portion 206), the mesh portions may be positioned below the holes or slots in the rounded interior pocket 204. Accordingly, the slots 208 may provide ventilation, while the mesh portion(s) prevent the item 300 from entering the holes or slots 208, which may otherwise damage the item 300.

The distribution of low pressure inside the housing portion 202 can be achieved by having the item rest against the mesh while a suction force is being applied. This ensures that the low pressure is evenly distributed throughout the interior of the housing portion 202. The mesh may also vent to the vacuum source, and the slots 208 should be deep enough to keep an open path for airflow regardless of how the item 300 deforms during grasping.

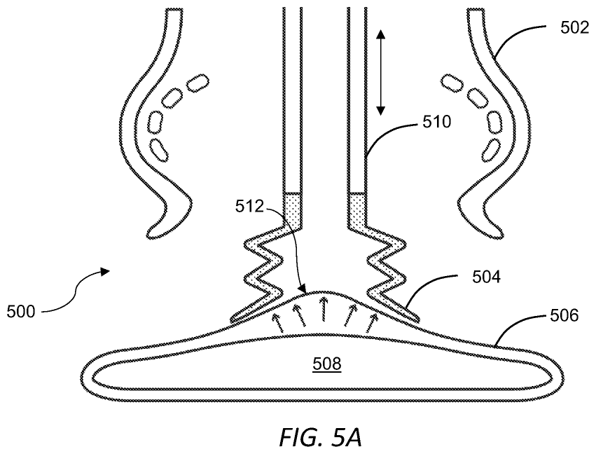

FIG. 4 illustrates a cross-sectional view of a suction cup device 400 in accordance with another embodiment. The suction cup device 400 may include a rigid housing portion 402, a rounded interior pocket 404, and a plurality of holes or slots 406 (for simplicity, “slots 406”). The suction cup device 400 may also include an internal lip portion 408 extending into the rounded interior pocket 404.

This internal lip portion 408 may allow the otherwise rigid suction cup device 400 to better conform to a bagged item around the location where the vacuum seal is achieved. The internal lip portion 408 may be formed from a flexible material such as, but not limited to, rubber, silicone, neoprene, vinyl, nitrile, or the like. The internal lip portion 408 may be operably connected to or otherwise joined with the rigid housing portion 408 via an adhesive or a press fit or other type of mechanical connection.

The suction cup device 400 may also include an external lip portion 410 that extends away from the opening. The external lip portion 410 may enable the suction cup device 400 to pick larger rigid or semi-rigid objects suction as boxes. That is, the external lip portion 410 increases the area by which the suction cup device 400 contacts an item.

In some embodiments, the internal lip portion 408 and the external lip portion 410 may be formed as a single component. In some embodiments, the internal lip portion 408 and the external lip portion 410 may be formed as two or more components.

The suction cup devices described herein may be configured in a variety of sizes. For example, the inner diameter of the opening through which a suction source is applied may vary and may depend on the application. The diameter may be dependent on the item(s) to be grasped, the available suction force, or the like.

The suction cup devices described herein may also vary in terms of sizes or shapes. For example, the number, shape, and placement of the holes or slots may vary and may depend on the application.

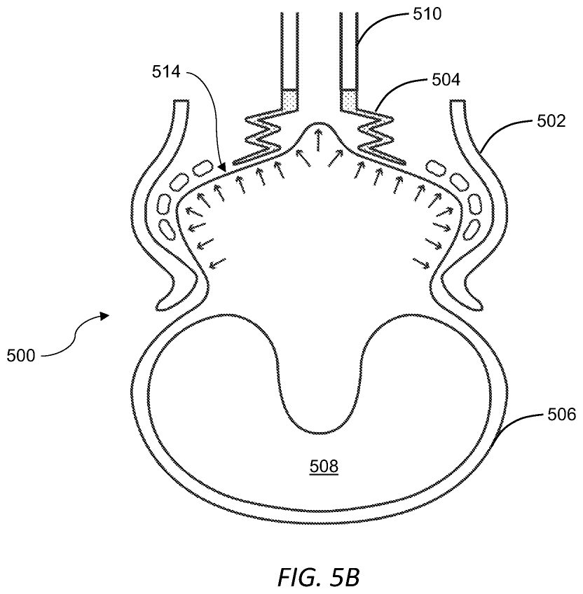

In some embodiments, the suction cup devices described herein may be implemented in a nested configuration. For example, FIG. 5A illustrates a suction cup apparatus 500 in accordance with one embodiment. As seen in FIG. 5A, the apparatus 500 includes a rigid housing 502 and an inner suction cup device 504 nested or otherwise position within the rigid housing 502. For example, the suction cup device 504 may be concentric with the rigid housing 502.

The suction cup device 504 may obtain an initial grasp on an item 506, such as a polybag that contains one or more internal items 508. The suction cup device 504 may be operably connected to a linear extension element 510 that extends and retracts the suction cup device 504.

In operation, the suction cup apparatus 500 may be moved toward an item to be picked. The suction cup apparatus 500 may be attached to one or more robotic arms or manipulators (not shown in FIG. 5A) that are configured to position the suction cup apparatus 500 to perform a picking operation. For example, the robotic arms may position the suction cup apparatus 500 such that it is close enough to a bin or other pick location from which the suction cup apparatus 500 can grasp an item.

In some embodiments, the suction cup apparatus 500 may be positioned over a conveyor belt that delivers items to be picked. In these embodiments, the suction cup apparatus 500 may be stationary.

The linear extension element 510 or a portion thereof may be modular or otherwise interchangeable in nature such that the suction cup apparatus 500 can accommodate different types of suction devices and therefore grasp different items. The inner suction cup device 504, the linear extension element 510, or both, may be interchangeable, either manually or by using an automated exchange system.

To perform a grasp attempt, the linear extension element 510 may first extend the suction cup device 504 toward the item 506. The suction device 504 and the linear extension element 510 may be activated in a variety of ways. For example, a motor may drive the linear extension element 510 to extend towards the item 506 and retract once the inner suction cup device 504 obtains an initial grasp on the item 506.

In some embodiments, the motor may be an off-the-shelf motor with a machined frame to drive a gear train. The driven gear train may include a series of gears and/or a screw in operable connectivity with the extension element 510. As the motor and gear train drive the linear extension element 510, they may also drive the inner suction cup device 504 by virtue of its connection to the linear extension element 510.

In some embodiments, the linear extension element 510 may be driven by one or more external forces. For example, the inner suction cup device 504 may be mounted on spring-activated pistons. This allows the linear extension element 510 to engage or otherwise receive progressively larger suction cup devices, as the overall picking system drives the suction devices further “into” the items. In other embodiments, a piston such as a hydraulic- or pneumatic-activated piston may extend or retract the linear extension element 510.

In some embodiments, the inner suction cup device 504 may move via passive means. In these types of embodiments, the suction cup device 504 may be in operable connectivity with one or more bellows. These bellows may collapse upon the inner suction cup device 504 obtaining an initial grasp on the item 506. This may cause the pressure inside the bellows to decrease, which in turn causes a retracting force. In other words, the collapse of the bellows naturally moves the suction cup device 504 and the item 506 toward the rigid housing 502.

Other passive embodiments may rely on one or more pistons. For example, a piston in operable connectivity with the linear extension element 510 or the suction cup device 504 may be driven by a vacuum force. The vacuum force may cause the piston to drive the linear extension element 510 (and therefore the suction cup device 504) toward the item. Upon contacting the item 506, the decrease in pressure may cause the piston to retract the linear extension element 510 and the suction cup device 304.

As seen in FIG. 5A, once the inner suction cup device 504 obtains an initial grasp on the item 506, a portion of the item 506 is exposed to low pressure 512 “within” the suction cup device 504. This low pressure 512, indicating that the inner suction cup device 504 has obtained an initial grasp on the item 506, may be detected by one or more sensor devices (not shown in FIG. 5A).

The suction cup apparatus 500 may include one or more processor devices executing instructions stored in memory for analyzing received sensor data. For example, the one or more processors may detect a change in pressure that exceeds some threshold to indicate the suction cup device 504 has grasped the item 506. In some embodiments, the one or more processors may recognize a pressure level to be associated with a successful grasp.

Upon detecting the low pressure 512 or otherwise identifying that the inner suction cup device 504 has grasped the item 506, the linear extension element 510 may retract and bring the inner suction cup device 504 toward the rigid housing 502. The rigid housing 502 may also be operably connected to a vacuum force generator.

In some embodiments, the rigid housing 502 may be connected to the same generator that is connected to the inner suction cup device 504. In some embodiments, the rigid housing 502 may be connected a generator that is different than the generator that is connected to the inner suction cup device 504. In some embodiments, a vacuum flow providing low pressure to the inner suction cup device 504 and the rigid housing 502 may be controlled independently or as a group.

The embodiments herein may use various vacuum generation methods, techniques, or systems. For example, Venturi devices may provide any combination of pressure and flow and are well-suited to produce high pressures and low flows. Blower devices are another possible technique, and may produce extremely high flow rates.

Different types of suction cup devices or those of different sizes may require different amounts of flow to sufficiently grasp an item. Although a higher total amount of pressure may increase the strength of the grasp or grip, an unnecessarily high amount of pressure may damage the item.

Large suction devices (e.g., suction devices with a large opening diameter) may benefit from higher flow rates and lower pressures. The high flow rate can not only help achieve an initial grasp on items, but also compensate for any leaks caused by the large sealing area. Additionally, the lower pressures reduce the likelihood of damaging items.

FIG. 5B illustrates the suction cup apparatus 500 of FIG. 5A in a retracted state in accordance with one embodiment. As seen in FIG. 5B, the linear extension element 510 has pulled the inner suction cup device 504 toward the rigid housing 502. At this point, the suction force generated by or associated with the rigid housing 502 may also act on the item 506.

As or after the inner suction cup device 504 is brought closer to the rigid housing 502, a portion 514 of the item 506 is exposed to low pressure outside of the inner suction cup device 504 but within the rigid housing 502.

The suction force generated in the rigid housing 502 may pull at least a portion of the item 506 up into the interior of the rigid housing 502. For example, the item 506 may be pulled up toward the holes or slots 316.

The suction cup apparatus 500 of FIGS. 5A & 5B is exemplary, and other configurations or types of suction cup devices may be used in accordance with the embodiments herein. For example, the rigid housing portion 520 may be replaced by a rubber or otherwise flexible suction cup device. As another example, an apparatus may include multiple suction cup devices, each with its own “inner” suction cup device nested therein.

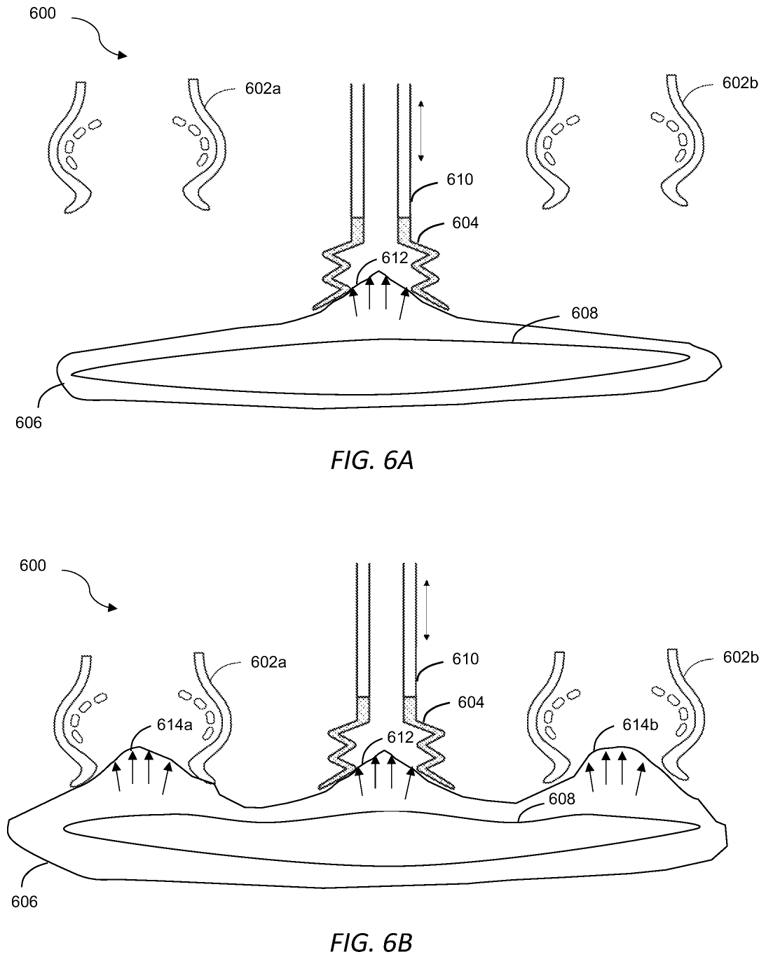

FIGS. 6A & and 6B illustrate a cross-sectional view of a suction cup apparatus 600 in accordance with another embodiment. The suction cup apparatus 600 may include one more housings 602a and 602b, and a suction cup device 604 positioned between housings 602a and 602b. For example, the housings 602a and 602b may be equidistant from the suction cup device 604.

The suction cup device 604 may obtain an initial grasp on an item 606, such as a polybag that contains one or more internal items 608. The suction cup device 604 may be operably connected to a linear extension element 610 that extends and retracts the suction cup device 604.

In operation the suction cup apparatus 600 may be moved toward an item to be picked. The suction cup apparatus 600 may be attached to one or more robotic arms or manipulators (not shown in FIG. 6A) that are configured to position the suction cup apparatus 600 to perform a picking operation. For example, these robotic arm(s) may position the suction cup apparatus 600 such that the suction cup device 604 is close enough to a bin or other pick location from which the suction cup device 604 can grasp an item.

The linear extension element 610 or a portion thereof may be modular or otherwise interchangeable in nature such that the suction cup apparatus 600 can accommodate different types of suction devices and therefore grasp different items. The suction cup device 604, the linear extension element 610, or both, may be interchangeable, either manually or by using an automated exchange system.

To perform a grasp attempt, the linear extension element 610 may first extend the suction cup device 604 toward the item 606. The suction device 604 and the linear extension element 610 may be activated in a variety of ways. For example, a motor may drive the linear extension element 610 to extend towards the item 606 and retract once the suction cup device 604 obtains an initial grasp on the item 606. The linear extension element 610 may be configured similarly to linear extension element 510 of FIGS. 5A & 5B. Similarly, the suction cup device 604 may operate similarly the suction cup device 504 of FIGS. 5A & 5B.

In some embodiments, the linear extension element 610 may be driven by a vacuum force. The vacuum force may cause a piston to drive the linear extension element 610 (and therefore the suction device 604) toward the item 606. Upon contacting the item 606, the decrease in pressure may cause the piston to retract the linear extension element 610 and the suction cup device 604.

As seen in FIG. 6A, once the suction cup device 604 obtains an initial grasp on the item 606, a portion of the item 606 is exposed to lower pressure 612 “within” the suction cup device 604. This low pressure 612 indicates that the suction cup device 604 has obtained an initial grasp on the item 606 and may be detected by one or more sensor devices (not shown in FIG. 6A).

As discussed in conjunction with FIGS. 5A & 5B, the suction cup apparatus 600 may include one or more processor devices executing instructions stored in memory for analyzing received sensor data. For example, the one or more processors may detect a change in pressure that exceeds some threshold to indicate the suction cup device 604 has grasped the item 606. In some embodiments, the one or more processors may recognize a pressure level to be associated with a successful grasp.

Upon detecting the low pressure 612 or otherwise identifying that the suction cup device 604 has grasped the item 606, the linear extension element 610 may retract the suction cup device 604 and toward the housings 602a and 602b. The housings 602a and 602b may each be operably connected to a vacuum force generator. In some embodiments, one of or both of housings 602a and 602b may be connected to the same generator that is connected to the suction cup device 604. In some embodiments, the housings 602a and 602b may be connected to a generator that is different than the generator that is connected to the suction cup device 604. In some embodiments, a vacuum flow providing low pressure to the inner suction cup device 604 and the housings 602a and 602b may be controlled independently or as a group.

FIG. 6B illustrates the suction cup apparatus 600 of FIG. 6A in a retracted state in accordance with one embodiment. As seen in FIG. 6B, the linear extension element 610 has pulled the suction cup device 604 toward the housings 602a and 602b. Once the item is sufficiently close to the housings 602a and 602b, the suction force generated by or otherwise associated with the housings 602a, 602b, or both may also act on the item. Accordingly, as or after the suction cup device 604 is brought closer to the housings 602a, 602b, or both, a portion 614a and 614b of the item 606 may be exposed to low pressure within the respective housings, 602a and 602b.

The suction cup apparatus 600 of FIGS. 6A & 6B is exemplary. For example, the suction cup apparatus 600 may include multiple housings 602a, 602b, 602n, where n is the number of housings. These housings may be operably positioned about one or more suction cup devices, such that multiple suction cup devices such the suction cup device 604 may obtain an initial grasp on an item, and then multiple housings such as housing 602a may subsequently obtain a grasp on the item.

The types of components of the suction cup apparatus 600 may also vary. For example, a suction cup device such as suction cup device 604 may replace the housings 602a and 602b.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A suction apparatus for performing a picking operation, the suction apparatus comprising:
a first suction device including:
a housing portion, wherein the housing portion is shaped to define an opening through which a suction force can be applied to enable the first suction device to grasp an item; and
a rounded interior pocket adjacent to the opening of the housing portion, wherein the rounded interior pocket is shaped to contact at least a portion of the item during the picking operation.

2. The suction apparatus of claim 1 further comprising a convexed lip portion at the opening such that the item slides against the convexed lip portion during the picking operation.

3. The suction apparatus of claim 1 wherein:
the opening has a first diameter, and
the housing portion has a second diameter that is greater than the first diameter.

4. The suction apparatus of claim 1 further comprising a mesh portion within the rounded interior pocket, wherein the mesh portion includes a plurality of apertures to distribute a low pressure force in the rounded interior pocket.

5. The suction apparatus of claim 4 wherein the mesh portion traverses a circumference of the rounded interior pocket.

6. The suction apparatus of claim 5 wherein the mesh portion has a curved shape to allow for a flexible item to conform to the mesh portion during the picking operation.

7. The suction apparatus of claim 4 wherein the mesh portion is shaped to allow a vacuum around the rounded interior pocket.

8. The suction apparatus of claim 7 wherein the housing portion is configured to allow a free flow of air around the mesh portion regardless of whether the item seals off a portion of a surface of the rounded interior pocket.

9. The suction apparatus of claim 1 further comprising an external lip portion extending from the opening and configured to be in operable contact with the item during the picking operation.

10. The suction apparatus of claim 1 further comprising an internal lip portion extending from the opening and into the rounded interior pocket, wherein the internal lip portion is configured to conform to the item during the picking operation.

11. The suction apparatus of claim 1 further comprising:
a linear extension member extendable through a center of the housing portion, and
a second suction device operably connected to the linear extension member and including an opening through which a suction force can be applied to enable the second suction device to obtain an initial grasp on the item.

12. The suction apparatus of claim 11 wherein the linear extension member is configured to:
move the second suction device toward the item to enable the second suction device to obtain an initial grasp on the item, and
retract the second device upon the second suction device obtaining the initial grasp on the item to enable the first suction device to grasp the item.

13. A method for performing a picking operation, the method comprising:
positioning a linear extension member within a first suction device, wherein the first suction device includes:
a housing portion, wherein the housing portion is shaped to define an opening through which a suction force can be applied to enable the first suction device to grasp an item, and
a rounded interior pocket adjacent to the opening of the housing portion, wherein the rounded interior pocket is shaped to contact at least a portion of the item during the picking operation;
moving, using the linear extension member, a second suction device toward an item to be grasped to enable the second suction device to obtain an initial grasp on the item; and
retracting the linear extension member to the first suction device to enable the first suction device to grasp the item.

14. The method of claim 13 wherein the first suction device includes a convexed lip portion at the opening such that the item slides against the convexed lip portion during the picking operation.

15. The method of claim 13 wherein the opening of the first suction device has a first diameter and the housing portion has a second diameter that is greater than the first diameter.

16. The method of claim 13 wherein the first suction device further includes a mesh portion within the rounded interior pocket, wherein the mesh portion includes a plurality of apertures to distribute a low pressure force in the round interior pocket.

17. The method of claim 16 wherein the mesh portion traverses a circumference of the rounded interior pocket.

18. The method of claim 17 wherein the mesh portion has a curved shape to allow for a flexible item to conform to the mesh portion during the picking operation.

19. The method of claim 13 wherein the first suction device further includes an external lip portion extending from the opening and configured to be in operable contact with the item during the picking operation.

20. The method of claim 13 wherein the first suction device further includes an internal lip portion extending from the opening and into the rounded interior pocket, wherein the internal lip portion is configured to conform to the item during the picking operation.
